(19) United States
(12) Patent Application Publication
(10) Pub. No.: US 2024/0251749 A1
(43) Pub. Date: Aug. 1, 2024

(54) WATER ABSORPTION TREATMENT MATERIAL AND METHOD FOR MANUFACTURING THE SAME

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 18/596,987

(22) Filed: Mar. 6, 2024

Related U.S. Application Data
(63) Continuation of application No. PCT/JP22/29496, filed on Aug. 1, 2022.

(30) Foreign Application Priority Data
Oct. 6, 2021 (JP) 2021-164375

(51) Int. Cl. A01K 1/015

(52) U.S. Cl. CPC A01K 1/0155

(57) ABSTRACT

A water absorption treatment material includes a plurality of grains having a water absorbing property. Each of the grains contains rice flour as a main material.

### CROSS REFERENCE TO RELATED APPLICATION

This is a Continuation of International Application No. PCT/JP2022/029496 filed Aug. 1, 2022, which claims the benefit of Japanese Application No. 2021-164375 filed Oct. 6, 2021. The contents of these applications are hereby incorporated by reference in their entirety.

### TECHNICAL FIELD

The present invention relates to a water absorption treatment material that absorbs liquid, and a method for manufacturing the same.

### BACKGROUND ART

A conventional water absorption treatment material is disclosed, for example, in Patent Document 1. The water absorption treatment material disclosed in Patent Document 1 is an excrement treatment material for animals that is composed of a large number of grains having a water absorbing property. Each grain is made mainly of pulverized bamboo pieces obtained by pulverizing a dry bamboo material, and bentonite.

### CITATION LIST

### Patent Document

Patent Document 1: JP 2004-201520 A

### SUMMARY OF INVENTION

### Technical Problem

The water absorption treatment material described above is usually used in a state in which the large number of grains are laid in a box-shaped toilet. However, an animal sometimes accidentally ingests the grains laid in the toilet. This is a factor in harming health of the animal.

### Solution to Problem

The present invention has been made in view of the above-described problem, and it is an object thereof to provide a water absorption treatment material having high safety when accidental ingestion, and a method for manufacturing the same.

A water absorption treatment material according to the present invention includes a plurality of grains having a water absorbing property, wherein each of the grains contains rice flour as a main material.

In this water absorption treatment material, the grains are provided that contain rice flour as a main material. As used herein, the main material refers to the material that accounts for the highest weight ratio in each grain, out of one or more materials constituting the grain. Using rice flour, which is a food material, as the main material in this way can reduce health damage of an animal, even in the case where the animal accidentally ingests the grains.

A method for manufacturing a water absorption treatment material according to the present invention includes a grain forming step of forming a plurality of grains having a water absorbing property, wherein in the grain forming step, the plurality of grains are formed such that each of the grains contains rice flour as a main material.

In this manufacturing method, the grains are formed that contain rice flour as a main material. Using rice flour, which is a food material, as the main material in this way can reduce health damage of an animal in a manufactured water absorption treatment material, even in the case where the animal accidentally ingests the grains.

### Advantageous Effects of Invention

According to the present invention, it is possible to implement a water absorption treatment material having high safety when accidental ingestion, and a method for manufacturing the same.

### BRIEF DESCRIPTION OF DRAWINGS

FIG. 1 is a schematic view showing an embodiment of a water absorption treatment material according to the present invention.

FIG. 2 is a schematic view showing a grain 10.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

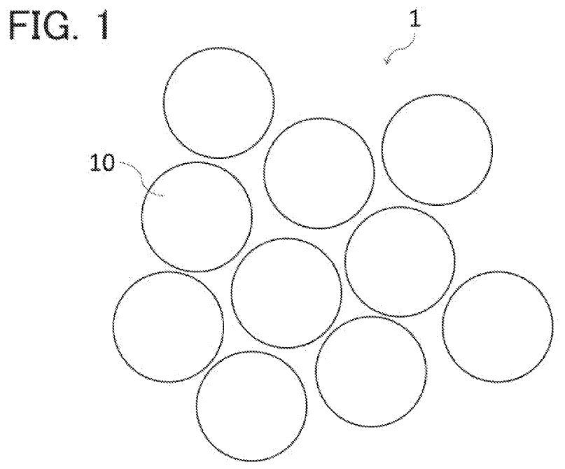

FIG. 1 is a schematic view showing an embodiment of a water absorption treatment material according to the present invention. A water absorption treatment material 1 is a water absorption treatment material that absorbs liquid to be treated, and includes a plurality of grains 10. The particle diameter of each grain 10 is, for example, between 5 mm and 20 mm inclusive. As used herein, the particle diameter is defined as the diameter of the minimum sphere that can include each grain 10. In the present embodiment, the water absorption treatment material 1 is an excrement treatment material that absorbs excrement (mainly urine) of animals such as cats or dogs. The water absorption treatment material 1 is used, for example, in a state in which the plurality of grains 10 are laid in a box-shaped toilet.

Each grain 10 has a water absorbing property. The grain 10 having the water absorbing property requires the water absorption rate of 40% or more measured by the following test. First, approximate 50 grams of the grains 10 (sample) are placed in a sieve with the inner diameter of 10 cm and the mesh size of 1 mm. An empty beaker is set under the sieve. Then, 30 ml of water is dripped on the sample over 10 seconds using a syringe with the inner diameter of its outer cylinder of 3 cm and the inner diameter of its cylinder tip of 4 mm (60 ml syringe manufactured by Terumo Corp.). After waiting 1 minute, the quantity of the water in the beaker is measured. The ratio of the value obtained by subtracting the measured water quantity from the quantity of the dripped water (30 ml) with respect to the quantity of the dripped water shall be the water absorption rate. That is, if the water quantity in the beaker is 18 ml or less, the water absorption rate is 40% or more, and therefore the grain 10 is found to have the water absorbing property.

Each grain 10 contains rice flour as a main material. That is, the rice flour accounts for the highest weight ratio in materials constituting each grain 10. The weight ratio of the rice flour with respect to each grain 10 is preferably 50% or more, and more preferably 80% or more. The rice flour may be an alpha type or a beta type. Also, each grain 10 may contain two or more kinds of rice flour. In that case, “the weight ratio of rice flour” shall be equal to the total weight ratios of all types of the rice flour contained in each grain 10.

It is preferable that each grain 10 is made only of food materials. That is, it is preferable that all materials constituting the grain 10 other than rice flour are also food materials. The food materials shall include food additives such as food colorant. Also, it is preferable that each grain 10 is made only of an organic substance.

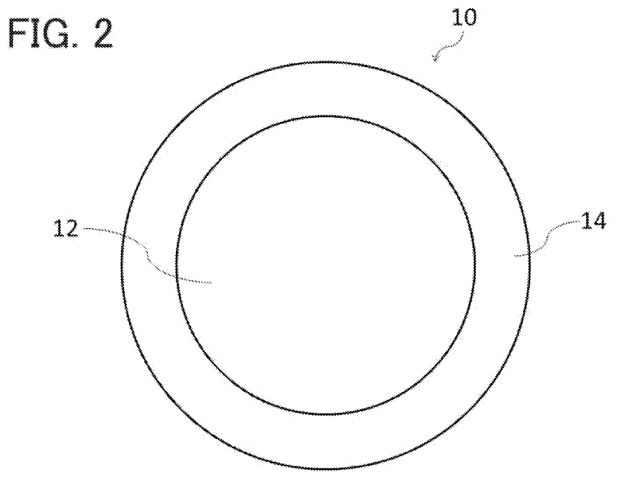

FIG. 2 is a schematic view showing the grain 10. Each grain 10 includes a core portion 12 (granule), and a coating portion 14. The core portion 12 has a granular shape. Examples of the granular shape include a sphere, column, and ellipsoid. The core portion 12 has a function of absorbing and retaining liquid. The core portion 12 contains rice flour. The main material of the core portion 12 is the rice flour. As used herein, the main material of the core portion 12 refers to the material that accounts for the highest weight ratio in the core portion 12, out of one or more materials (core portion material) constituting the core portion 12. The core portion 12 may or may not contain a water-absorbent material other than rice flour. Examples of the water-absorbent material other than rice flour include papers, used tea leaves, plastics, and bean curd lees. The bean curd lees out of these materials correspond to the food materials. On the other hand, the papers, used tea leaves, and plastics do not correspond to the food materials.

The papers refer to a material composed mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, for example, a disposable diaper classified product (plastic obtained by classifying disposable diapers) may be used. The bean curd lees are preferably dried bean curd lees.

The coating portion 14 covers the core portion 12. The coating portion 14 may cover the entire surface of the core portion 12, or may cover only a part of the surface of the core portion 12. The coating portion 14 has a function (agglomeration forming function) of bonding the grains 10 that have absorbed liquid to agglomerate them when in use. The coating portion 14 contains rice flour. The main material of the coating portion 14 is the rice flour. As used herein, the main material of the coating portion 14 refers to the material that accounts for the highest weight ratio in the coating portion 14, out of one or more materials (coating material) constituting the coating portion 14. The coating portion 14 may or may not contain a water-absorbent material other than rice flour.

The coating portion 14 contains an adhesive material. Examples of the adhesive material include starch, CMC (carboxymethyl cellulose), PVA (polyvinyl alcohol), dextrin, and a water-absorbent polymer. The water-absorbent polymer is, for example, sodium polyacrylate. The starch, CMC, PVA, and dextrin out of these materials correspond to the food materials. On the other hand, the water-absorbent polymer does not correspond to the food materials.

Next, an example of a method for manufacturing the water absorption treatment material 1 will be described as an embodiment of the method for manufacturing a water absorption treatment material according to the present invention. This manufacturing method includes a grain forming step.

The grain forming step is a step of forming the plurality of grains 10. The grain forming step includes a core portion forming step, and a coating portion forming step. The core portion forming step is a step of forming a plurality of the core portions 12. In the core portion forming step, the plurality of core portions 12 that are granules are formed by granulating the core portion material with a granulation apparatus. As the granulation apparatus, for example, an extrusion granulator can be used. Prior to the granulation, pretreatment such as pulverization, kneading, and adding water is performed on the core portion material as needed. In the present embodiment, rice flour is contained in the core portion material as a main material, and the core portions 12 containing the rice flour as the main material are formed.

The coating portion forming step is a step of forming the coating portions 14. In this step, the coating portions 14 are formed by attaching the powdery coating material to the surface of each core portion 12 with a coating apparatus or the like. The coating material can be attached by, for example, sprinkling or spraying. In the present embodiment, rice flour is contained also in the coating material as a main material, and the coating portions 14 containing the rice flour as the main material are formed. After the granulation, posttreatment such as sieving (sizing), and drying is performed as needed. Accordingly, the water absorption treatment material 1 composed of the plurality of grains 10 is obtained.

The effects of the present embodiment will be described. In the present embodiment, the grains 10 are formed that contain rice flour as a main material. Using rice flour, which is a food material, as the main material in this way can reduce health damage of an animal in the water absorption treatment material 1, even in the case where the animal accidentally ingests the grains 10. Accordingly, the water absorption treatment material 1 having high safety when accidental ingestion, and the method for manufacturing the same are implemented.

Enlarging the weight ratio of the rice flour with respect to each grain is advantageous for enhancing safety when accidental ingestion. From this viewpoint, the weight ratio of the rice flour with respect to each grain 10 is preferably 50% or more, and more preferably 80% or more.

Each grain 10 has multi-layer structure (double-layer structure) composed of the core portion 12 and the coating portion 14. Thus, the core portion 12 and the coating portion 14 can carry respective functions. For example, in the present embodiment, the function of absorbing and retaining liquid is carried mainly by the core portion 12, and the agglomeration forming function is carried by the coating portion 14.

The coating portion 14 contains an adhesive material. Thus, the agglomeration forming function can be imparted to the coating portion 14. However, it is not essential that the coating portion 14 contains an adhesive material.

The rice flour is contained in both the core portion 12 and the coating portion 14. In this case, it becomes easier to enlarge the weight ratio of the rice flour with respect to each grain 10, compared to a case where the rice flour is contained only in either one of the core portion 12 or the coating portion 14.

In the case where each grain 10 is made only of food materials, it is possible to particularly enhance safety when accidental ingestion.

In the case where each grain 10 is made only of an organic substance, the grains 10 can be obtained that are suitable for being disposed of by incineration. In this case, used grains 10 can be disposed of as burnable garbage, which therefore increases convenience for users.

The present invention is not limited to the above-described embodiment, and various modifications can be made. In the above-described embodiment, an example is given in which rice flour is contained in both the core portion 12 and the coating portion 14. However, rice flour may be contained only in either one of the core portion 12 or the coating portion 14. In the case where rice flour is contained only in the core portion 12, it is possible to enhance the degree of freedom in selecting the coating material.

In the above-described embodiment, an example is given in which each grain 10 has multi-layer structure composed of the core portion 12 and the coating portion 14. However, it is not essential to provide the coating portion 14. That is, each grain 10 may have single-layer structure composed only of an uncovered granule (core portion 12). In that case, it is possible to reduce the manufacturing cost of the water absorption treatment material 1, because the coating material becomes unnecessary.

In the above-described embodiment, each grain 10 may consist essentially of rice flour. As used herein, “consisting essentially of rice flour” means that an additive material such as coloring matter or perfume may be contained in each grain 10 unless the water absorbing property of the grain is inhibited. Even in that case, it is preferable that the weight ratio of the additive material with respect to each grain 10 is 1% or less (namely, the weight ratio of the rice flour is 99% or more). In the case where each grain consists essentially of rice flour in this way, it is possible to further enhance safety when accidental ingestion.

In the above-described embodiment, an example is given in which the water absorption treatment material 1 is an excrement treatment material. However, the water absorption treatment material 1 may be a vomit treatment material that absorbs vomit, or a kitchen garbage treatment material that absorbs kitchen garbage (moisture contained in the kitchen garbage).

### LIST OF REFERENCE NUMERALS

1 Water Absorption Treatment Material
10 Grain
12 Core Portion (Granule)
14 Coating Portion

1. A water absorption treatment material comprising:
a plurality of grains having a water absorbing property,
wherein each of the grains contains rice flour as a main material.

2. The water absorption treatment material according to claim 1,
wherein a weight ratio of the rice flour with respect to each of the grains is 50% or more.

3. The water absorption treatment material according to claim 2,
wherein the weight ratio of the rice flour with respect to each of the grains is 80% or more.

4. The water absorption treatment material according to claim 1,
wherein each of the grains includes a granular core portion, and a coating portion that covers the core portion.

5. The water absorption treatment material according to claim 4,
wherein the rice flour is contained in both the core portion and the coating portion.

6. The water absorption treatment material according to claim 4,
wherein the rice flour is contained only in the core portion, out of the core portion and the coating portion.

7. The water absorption treatment material according to claim 1,
wherein each of the grains is composed of an uncovered granule.

8. The water absorption treatment material according to claim 7,
wherein each of the grains consists essentially of the rice flour.

9. The water absorption treatment material according to claim 1,
wherein each of the grains is made only of a food material.

10. The water absorption treatment material according to claim 1,
wherein each of the grains is made only of an organic substance.

11. A method for manufacturing a water absorption treatment material, the method comprising:
a grain forming step of forming a plurality of grains having a water absorbing property,
wherein in the grain forming step, the plurality of grains are formed such that each of the grains contains rice flour as a main material.

12. The method for manufacturing a water absorption treatment material according to claim 11,
wherein in the grain forming step, the plurality of grains are formed such that a weight ratio of the rice flour with respect to each of the grains is 50% or more.

13. The method for manufacturing a water absorption treatment material according to claim 12,
wherein in the grain forming step, the plurality of grains are formed such that the weight ratio of the rice flour with respect to each of the grains is 80% or more.

14. The method for manufacturing a water absorption treatment material according to claim 11,
wherein the grain forming step includes a core portion forming step of forming a plurality of granular core portions, and a coating portion forming step of forming coating portions so as to cover each of the core portions.

15. The method for manufacturing a water absorption treatment material according to claim 14,
wherein in the core portion forming step, the core portions that contain the rice flour are formed, and
in the coating portion forming step, the coating portions that contain the rice flour are formed.

16. The method for manufacturing a water absorption treatment material according to claim 14,
wherein in the core portion forming step, the core portions that contain the rice flour are formed, and
in the coating portion forming step, the coating portions that do not contain the rice flour are formed.

17. The method for manufacturing a water absorption treatment material according to claim 11,
wherein in the grain forming step, the plurality of grains are formed such that each of the grains is composed of an uncovered granule.

18. The method for manufacturing a water absorption treatment material according to claim 17,
wherein in the grain forming step, the plurality of grains are formed such that each of the grains consists essentially of the rice flour.

19. The method for manufacturing a water absorption treatment material according to claim 11,
wherein in the grain forming step, the plurality of grains are formed such that each of the grains is made only of a food material.

20. The method for manufacturing a water absorption treatment material according to claim 11,
wherein in the grain forming step, the plurality of grains are formed such that each of the grains is made only of an organic substance.
